(19) United States
(12) Patent Application Publication
(10) Pub. No.: US 2025/0131114 A1
(43) Pub. Date: Apr. 24, 2025

(54) PROTECTION OF DOCUMENTS BY QR CODE-BASED STAMP

(71) Applicant: zPaper, Inc., Roswell, GA (US)

(72) Inventor: Eric R. Stephens, Roswell, GA (US)

(21) Appl. No.: 18/999,133

(22) Filed: Dec. 23, 2024

Related U.S. Application Data
(63) Continuation of application No. 17/720,773, filed on Apr. 14, 2022, now Pat. No. 12,174,980.

(51) Int. Cl. G06F 21/62; G06K 19/06; H04L 67/02

(52) U.S. Cl. CPC G06F 21/6209; G06K 19/06037; H04L 67/02

(57) ABSTRACT

A system for protecting access to digital documents may include a blockchain network and a stamp generation node. The stamp generation node may receive a digital document and access parameters from a first user node. A unique identifier for the document may be generated and recorded on the blockchain with the access parameters. A QR code encoding a URL for accessing the document may be generated and embedded in the document. A shortened URL corresponding to the encoded URL may be generated and transmitted to a second user node. When accessed, the shortened URL may cause the stamp generation node to verify the access parameters on the blockchain and grant or deny access to the document based on the verification.

### RELATED APPLICATION

The present application is a Continuation of U.S. application Ser. No. 17/720,773 filed on Apr. 14, 2022, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to digital document protection, and more particularly, to method and system for protection of digital documents by generation of secure QR code-based stamp on a blockchain.

### BACKGROUND

This application generally relates to digital assets, and more particularly, to generation of digital stamp assets in blockchain networks based on QR codes.

Currently, blockchain is a decentralized and open system without a central regulation of certification authority. The blockchain technology has been adopted for trading of assets such as NFTs. NFT stands for a “non-fungible token,” and it can technically contain anything in a form of digital images or digital files. The digital images of documents require stamps that ensure authenticity and security of the digital document.

However, anyone can create a document with digital stamps as a blockchain asset, without having to prove their ownership or authenticity. The current authentication mechanisms suggested by the largest NFT blockchain provider Ethereum™ itself and by major trading platforms like OpenSea work only ex-post, to prove ownership after the asset (e.g., NFT) has been illegally minted and if discovered by the owners. The existing platforms are not able to prevent generation of fake documents with digital stamps that are illegally minted.

As such, what is needed is a blockchain-based solution that may be used for protection of digital documents by generation of QR code-based stamps for secure sharing of sensitive documents.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for generation of secure QR code-based stamp on a blockchain. The system includes a processor of a stamp generation node connected to at least one first user node and a second user node over a blockchain network; a memory on which are stored machine-readable instructions that when executed by the processor, cause the processor to:

A digital document protection system is disclosed. The system includes a processor of a stamp generation node connected to at least first user node and to a second user node over a blockchain network; a memory on which are stored machine-readable instructions that when executed by the processor, cause the processor to: receive a digital document from the first user node designated to the second user node; execute a smart contract to: generate a URL referencing a QR code and a unique tiny URL represented by the QR code, embed the QR code onto the document, wherein the document is accessible at the URL, and provide the tiny URL to the second node.

Another embodiment of the present disclosure provides a method that includes one or more of receiving a digital document from the first user node designated to the second user node; and executing a smart contract to: generate a URL referencing a QR code and a unique tiny URL represented by the QR code, embed the QR code onto the document, wherein the document is accessible at the URL, and provide the tiny URL to the second node.

Another embodiment of the present disclosure provides a computer-readable medium including instructions for receiving a digital document from the first user node designated to the second user node; and executing a smart contract to: generate a URL referencing a QR code and a unique tiny URL represented by the QR code, embed the QR code onto the document, wherein the document is accessible at the URL, and provide the tiny URL to the second node.

The system may receive, from a first user node, a digital document and access parameters for the digital document. The system may generate a unique identifier for the digital document. The system may record the unique identifier and access parameters on the blockchain network. The system may generate a QR code encoding a URL for accessing the digital document. The system may embed the QR code in the digital document. The system may generate a shortened URL corresponding to the URL encoded in the QR code. The system may transmit the shortened URL to a second user node. The shortened URL, when accessed by the second user node, may cause the stamp generation node to verify the access parameters recorded on the blockchain network. The system may grant or deny access to the digital document based on the verification.

The method may include receiving, by a stamp generation node on a blockchain network, a digital document from a first user node. The method may include generating, by the stamp generation node, a unique identifier for the digital document. The method may include recording, by the stamp generation node, the unique identifier on a blockchain ledger of the blockchain network. The method may include generating, by the stamp generation node, a URL for accessing the digital document. The method may include creating, by the stamp generation node, a QR code that encodes the URL. The method may include embedding, by the stamp generation node, the QR code into the digital document. The method may include generating, by the stamp generation node, a shortened URL that corresponds to the URL encoded in the QR code. The method may include transmitting, by the stamp generation node, the shortened URL to a second user node. The method may include receiving, by the stamp generation node, an access request from the second user node containing the shortened URL. The method may include verifying, by the stamp generation node, access permissions for the second user node by querying the blockchain ledger. The method may include providing, by the stamp generation node, access to the digital document to the second user node in response to a determination that the access permissions are valid.

The system may include a plurality of nodes on a blockchain network, including a first user node configured to submit a digital document for protected sharing, a second user node configured to request access to the digital document, and a stamp generation node. The stamp generation node may be configured to receive the digital document from the first user node. The stamp generation node may generate a unique identifier for the digital document. The stamp generation node may record the unique identifier on a blockchain ledger. The stamp generation node may generate a URL for accessing the digital document. The stamp generation node may create a QR code encoding the URL. The stamp generation node may embed the QR code in the digital document. The stamp generation node may generate a shortened URL corresponding to the URL. The stamp generation node may transmit the shortened URL to the second user node. The stamp generation node may receive an access request from the second user node containing the shortened URL. The stamp generation node may retrieve one or more access parameters associated with the unique identifier from the blockchain ledger. The stamp generation node may verify the access request against the access parameters. The stamp generation node may grant access to the digital document based on the verification that the access request meets the retrieved access parameters.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting explanatory purposes of certain embodiments detailed in the present disclosure. In the drawings:

FIG. 1A illustrates a network diagram of a system for generation of a secure QR code-based stamp and stamped document processing on a blockchain, consistent with the present disclosure;

FIG. 1B illustrates a network diagram of a system including a detailed description of a stamp generation node, consistent with the present disclosure;

FIG. 2 illustrates an example blockchain architecture configuration, consistent with the present disclosure;

FIG. 3A illustrates a permissioned network, consistent with the present disclosure;

FIG. 3B illustrates another permissioned network, consistent with the present disclosure;

FIG. 3C illustrates a permissionless network, consistent with the present disclosure;

FIG. 4A illustrates a flow diagram of a method for generation of a secure QR code-based stamp on a blockchain, consistent with the present disclosure;

FIG. 4B illustrates a further flow diagram of a method of for generation of a secure QR code-based stamp on a blockchain, consistent with the present disclosure;

FIG. 5A illustrates an example system configured to perform one or more operations described herein, consistent with the present disclosure;

FIG. 5B illustrates another example system configured to perform one or more operations described herein, consistent with the present disclosure;

FIG. 5C illustrates a further example system configured to utilize a smart contract, consistent with the present disclosure;

FIG. 5D illustrates yet another example system configured to utilize a blockchain, consistent with the present disclosure;

FIG. 6 illustrates a process for a new block being added to a distributed ledger, consistent with the present disclosure; and

FIG. 7 illustrates a block diagram of a system including a computing device for performing the method of FIGS. 4A and 4B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing job applicants, embodiments of the present disclosure are not limited to use only in this context.

The present disclosure provides a system, method and computer-readable medium for generation of a secure QR code-based stamp on a blockchain.

In one embodiment of the present disclosure, the system provides a technology for enabling access and exchange of the highest fidelity document data user experience regardless of the initial transmission fidelity. In one embodiment the application utilizes a decentralized storage (such as a blockchain) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the records and no single peer can modify the records without a consensus being reached among the distributed peers. For example, the peers may execute a consensus protocol to validate blockchain storage and token-related transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permissionless blockchain, anyone can participate without a specific identity. Public blockchains can involve native cryptocurrency and use consensus based on various protocols such as Proof of Work (PoW). On the other hand, a permissioned blockchain provides secure interactions among a group of entities which share a common goal such as buying and selling of game tokens, but which do not fully trust one another.

This application can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

This application can utilize nodes that are the communication entities of the blockchain system. A “node” may perform a logical function in the sense that multiple nodes of different types can run on the same physical server or on different hosts. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of a node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

This application can utilize a ledger that is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain which is used to store an immutable, sequenced record in blocks. The ledger also includes a state database which maintains a current state of the blockchain.

This application can utilize a chain that is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Some benefits of the instant solutions described and depicted herein include a method and system for managing of assets such as game tokens in blockchain networks. The exemplary embodiments solve the issues of time and trust by extending features of a database such as immutability, digital signatures and being a single source of truth. The exemplary embodiments provide a solution for making transactions in cryptocurrency and game tokens over a blockchain-based network. The blockchain networks may be homogenous based on the asset type and rules that govern the assets based on the smart contracts.

Blockchain is different from a traditional database in that blockchain is not a central storage, but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system for management of buying and selling of game tokens using cryptocurrency in blockchain networks is implemented due to immutable accountability, security, privacy, permitted decentralization, availability of smart contracts, endorsements and accessibility that are inherent and unique to blockchain. In particular, the blockchain ledger data is immutable and that provides for efficient implementation of a method described herein. Also, use of the encryption in the blockchain provides security and builds trust. The smart contract manages the state of the asset to complete the life-cycle. The example blockchains are permission decentralized. Thus, each end user may have its own ledger copy to access. Multiple organizations (and peers) may be on-boarded on the blockchain network. The key organizations (e.g., a game token processing server) may serve as one of endorsing peers to validate the smart contract execution results, read-set and write-set. In other words, the blockchain inherent features provide for efficient implementation of the system and method described herein.

One of the benefits of the example embodiments is that it improves the functionality of a computing system by implementing a method for generation of secure QR code-based stamp using blockchain-based systems. Through the blockchain system described herein, a computing system can perform functionality for exchanging of sensitive digital documents (or NFTs) in blockchain networks by providing access to capabilities such as distributed ledger, peers, encryption technologies, event handling, etc. Also, the blockchain enables to create a secure network and make any users or organizations to on-board for participation. As such, the blockchain is not just a database. The blockchain comes with capabilities to create a Business Network (e.g., a game token exchange network) of users and on-board/off-board players to collaborate and execute service processes in the form of smart contracts.

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

Meanwhile, a traditional database could not be used to implement the example embodiments because it does not bring all parties on the charitable network, it does not create trusted collaboration and does not provide for an efficient storage and transfer of digital assets such as cryptocurrency, NFTS, and digital documents. The traditional database does not provide for a tamper proof storage and does not provide for preservation of the digital assets being stored. Thus, the proposed method for generation of secure QR code-based stamp on a blockchain network cannot be implemented in the traditional database.

Accordingly, the example embodiments provide for a specific solution to a problem in the arts/field of NFTs, documents and assets management. The example embodiments also change how data may be stored within a block structure of the blockchain. For example, a digital asset data may be securely stored within a certain portion of the data block (i.e., within header, data segment, or metadata). By storing the digital asset data within data blocks of a blockchain, the digital asset data may be appended to an immutable blockchain ledger through a hash-linked chain of blocks. In some embodiments, the data block may be different than a traditional data block by having QR code data associated with the digital asset not stored together with the assets within a traditional block structure of a blockchain. By removing the personal owner data associated with the digital asset, the blockchain can provide the benefit of anonymity based on immutable accountability and security.

According to the exemplary embodiments, a method system and computer readable media for generation of secure QR code-based stamp are provided.

QR code-based stamps are a novel way to use blockchain smart contracts and secure links so that existing storage, access, capture, and transmission systems can be extended to preserve or improve the signal to noise ratio and fidelity of exchanged document data. In one use case, stamped healthcare document data exchange can replace faxing so that clerical overhead, errors, and omissions are minimized and the right person gets the right care at the right time. The digital stamps, according to the disclosed embodiments, enable single document portal experiences delivered directly to patients, caregivers, and providers. The stamped healthcare document data exchange experiences can improve medical and financial outcomes and enable healthcare organizations to repurpose billions of hours and dollars that today are lost to inefficient clerical tasks and poorly timed treatment. Although especially relevant to the healthcare system, the disclosed digital stamps can be used in other markets and industries where documents are used to testify, consent, and gather data from parties. Those parties can be within one organization or across many organizations.

The disclosed digital stamps may, advantageously, work within the existing systems supporting dataDocuments (dD). A PDF file is a very common document format to which the digital stamps may be added to enable validation, access, and capture. These documents may be forms that include structured data, capture structured data, require a signature, or proof of delivery/receipt/acknowledgement. Minimally, there is metadata about the document indicating a source where the document is originated at, a target recipient the document is intended for, the times the document can be visited, a PIN for access, and a URL link that directs to web browser applications.

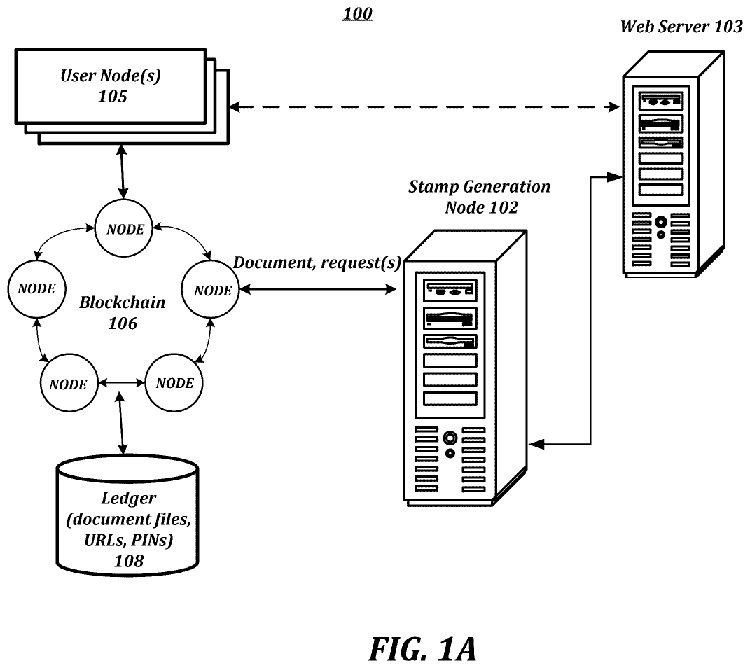

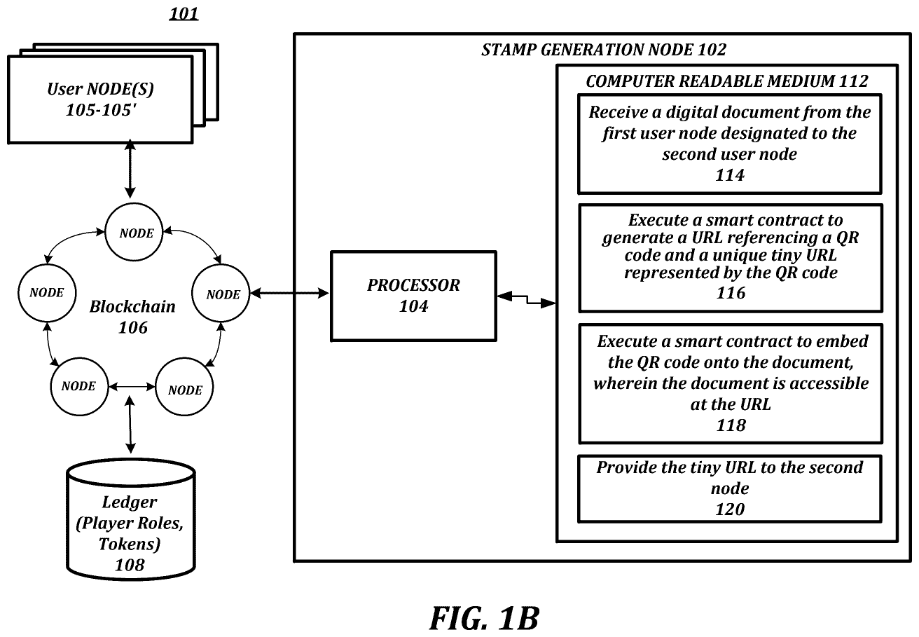

FIG. 1A illustrates a network diagram of a system for generation of a secure QR code-based stamp and stamped document processing on a blockchain, consistent with the present disclosure.

Referring to FIG. 1A, the example network 100 includes a stamp generation node 102 connected to other nodes 105 over blockchain network 106. The stamp generation node 102 may include additional components and that some of the components described herein may be removed and/or modified without departing from a scope of the stamp generation node 102 disclosed herein.

According to the disclosed embodiments, the stamp generation node 102 may be connected to user nodes 105 over a blockchain network 106 and may be connected to a cloud web server 103 off chain. The user nodes 105 may be connected to the web server 103 to access the protected digital documents using the URLs. The blockchain network 106 may have a ledger 108 that may store digital documents, URL, access PINs, etc.

In one embodiment, the stamp generation node 102 may generate QR code-based stamps to protect digital documents. The stamps may work within the existing systems supporting dataDocuments (dD). The stamp generation node 102 may receive a digital document that contains metadata about the document indicating a source where the document is originated at, a target recipient the document is intended for, the times the document can be visited, a PIN for access, and a URL link that directs to the document on the web server 103.

Each digital document has a ratio of structured to unstructured information or d to D. In a FAX, callers, the number of pages, and time of transmission are structured and the images are unstructured. If one thinks of structured to unstructured as signal to noise ratio, then a FAX is a 1% d/D, emailing a vector PDF is 50% d/D, and a direct message CCDA is 90% d/D. Using a H₂O metaphor, faxes are ice, files are water, and XML/JSON is steam. A disclosed stamp generation mechanism enables the access and exchange of the highest fidelity digital document experience among the user nodes 105 regardless of the initial transmission fidelity. User nodes 105 may send documents to be protected or document access requests to the stamp generation node 102.

In one embodiment, a regular URL U (i) can be represented as a tiny URL u (i+1) to create a chain of custody as new digital document elements are incorporated into a journey. Each chain element may have its own visit PIN, maximum visits counter, expiration date/time. Visit access to the original document is governed by the total chain since the tiny URL QR code is uniquely affixed to the digital document being transmitted. Each received transmission or transaction creates an activity. A fax receipt acknowledges the delivery of a certain number of pages at a certain time to a certain number but the user of the first node 105 has no idea if the user of the second node read all the pages or if the pages were blank because they scanned the wrong side or the ink ran out. Instead of another game of phone tag, the stamp generation node 102 executes a smart contract to register the use of the first URL and then enables the user of the second node to work directly with the original document to create a protected document and reply with this document owned by second URL and the chain is updated to end in in the second URL. The protected document includes the first document and the tiny URL and adds data and supporting documents digitally with an encrypted digital submission. That data may include eSignatures and may form data captured with HTML5 capable browser systems hosted on the web server 103.

FIG. 1B illustrates a network diagram of a system including a detailed description of a stamp generation node, according to example embodiments.

Referring to FIG. 1B, the example network 101 includes a stamp generation node 102 connected to user nodes 105 over a blockchain network 106. The stamp generation node 102 may include additional components and that some of the components described herein may be removed and/or modified without departing from a scope of the stamp generation node 102 disclosed herein. The stamp generation node 102 may be a computing device or a server computer, or the like, and may include a processor 104, which may be a semiconductor-based microprocessor, a central processing unit (CPU), an application specific integrated circuit (ASIC), a field-programmable gate array (FPGA), and/or another hardware device. Although a single processor 104 is depicted, it should be understood that the stamp generation node 102 may include multiple processors, multiple cores, or the like, without departing from the scope of the stamp generation node 102.

The stamp generation node 102 may also include a non-transitory computer readable medium 112 that may have stored thereon machine-readable instructions executable by the processor 104. Examples of the machine-readable instructions are shown as 114-120 and are further discussed below. Examples of the non-transitory computer readable medium 112 may include an electronic, magnetic, optical, or other physical storage device that contains or stores executable instructions. For example, the non-transitory computer readable medium 112 may be a Random-Access Memory (RAM), an Electrically Erasable Programmable Read-Only Memory (EEPROM), a hard disk, an optical disc, or other type of storage device.

A processor 104 may fetch, decode, and execute the machine-readable instructions 114 to receive a digital document from the first user node 105 designated to the second user node 105′. The processor 104 may fetch, decode, and execute the machine-readable instructions 116 to execute a smart contract to generate a URL referencing a QR code and a unique tiny URL represented by the QR code. The processor 104 may fetch, decode, and execute the machine-readable instructions 118 to execute a smart contract to embed the QR code onto the document, wherein the document is accessible at the URL. The processor 104 may fetch, decode, and execute the machine-readable instructions 120 to execute a smart contract to provide the URL to the second node.

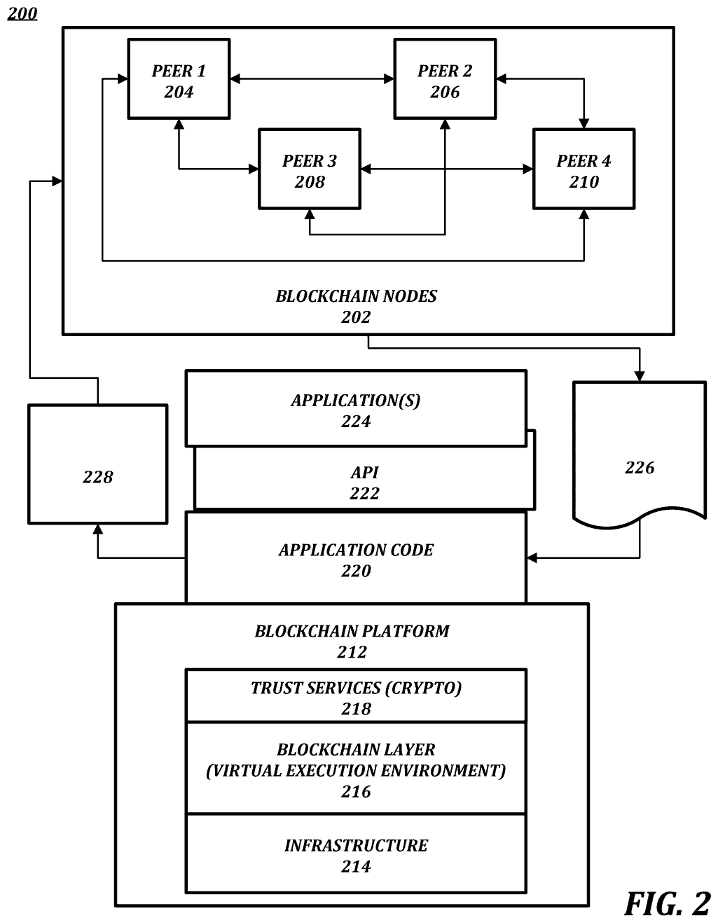

FIG. 2 illustrates a blockchain architecture configuration 200, according to example embodiments. Referring to FIG. 2, the blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2 may process and execute program/application code 220 via one or more interfaces exposed, and services provided, by blockchain platform 212. The code 220 may control blockchain assets such as NFTs. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the information 226 representing the QR stamp may be processed by one or more processing entities (e.g., virtual machines) included in the blockchain layer 216. The result 228 may include the stamped document being transferred to a user. The physical infrastructure 214 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in the blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

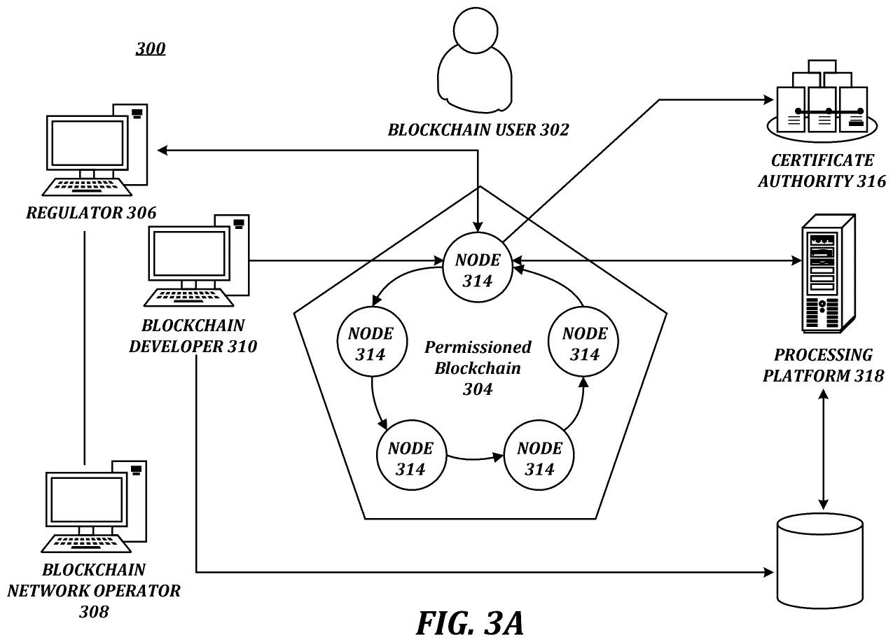

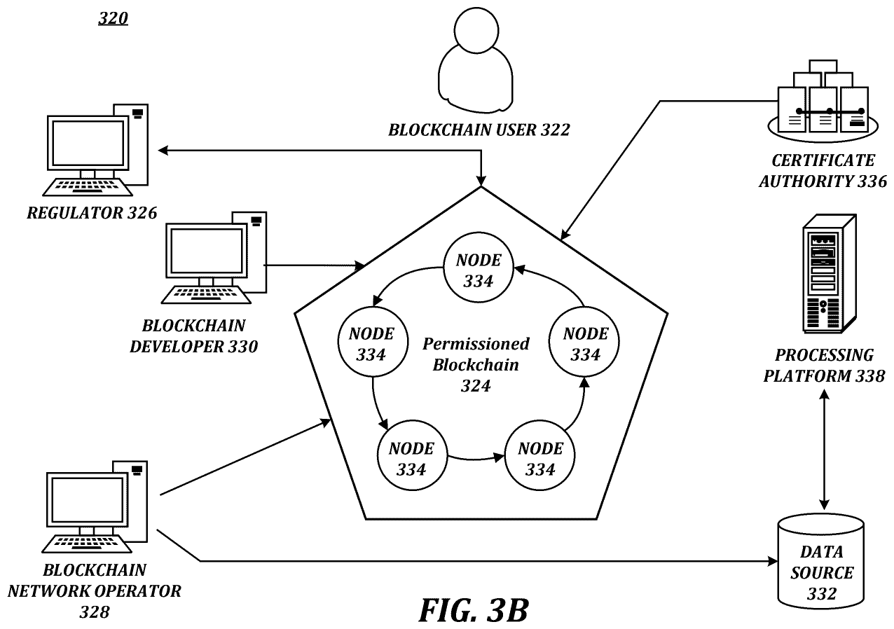

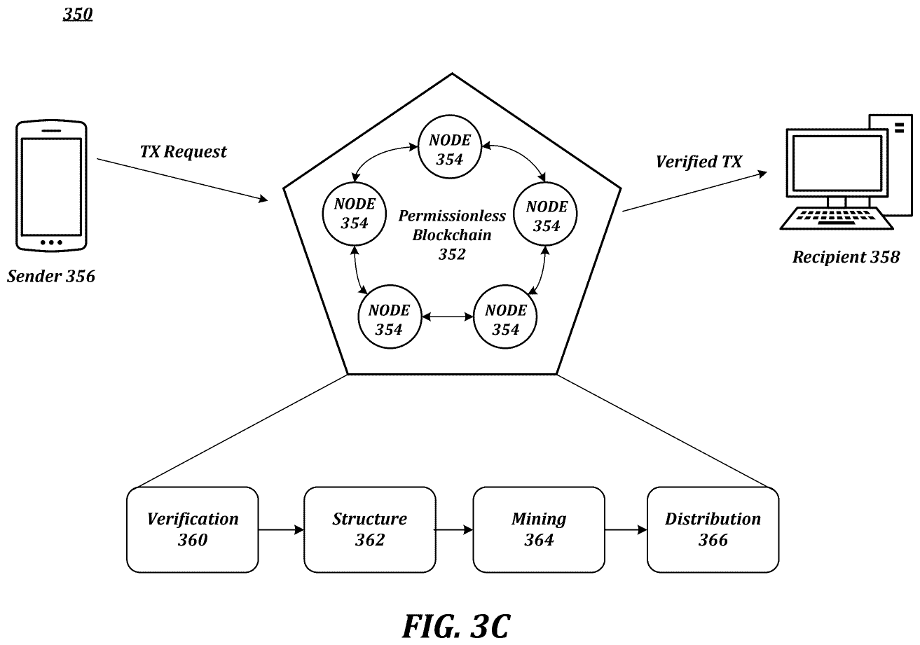

FIG. 3A illustrates an example of a permissioned blockchain network 300, which features a distributed, decentralized peer-to-peer architecture. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client.” An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client.” An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., NFTs or any other assets that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved (e.g., NFT owner, document owner, etc.). The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying block increases, and the number of subsequent blocks increases. With distribution 366, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

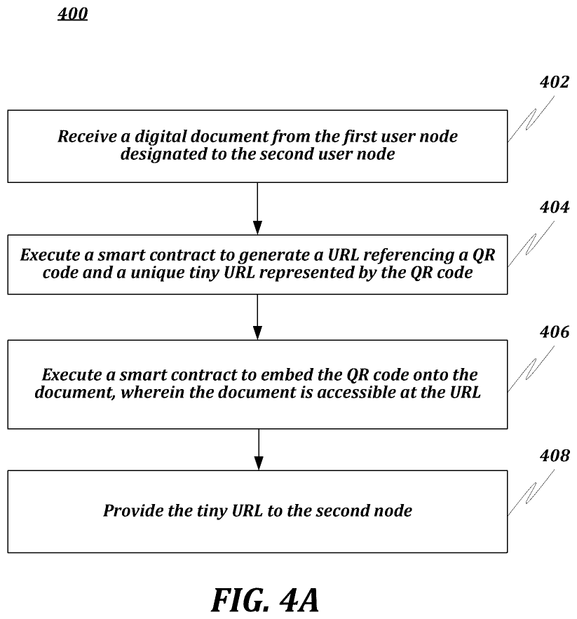

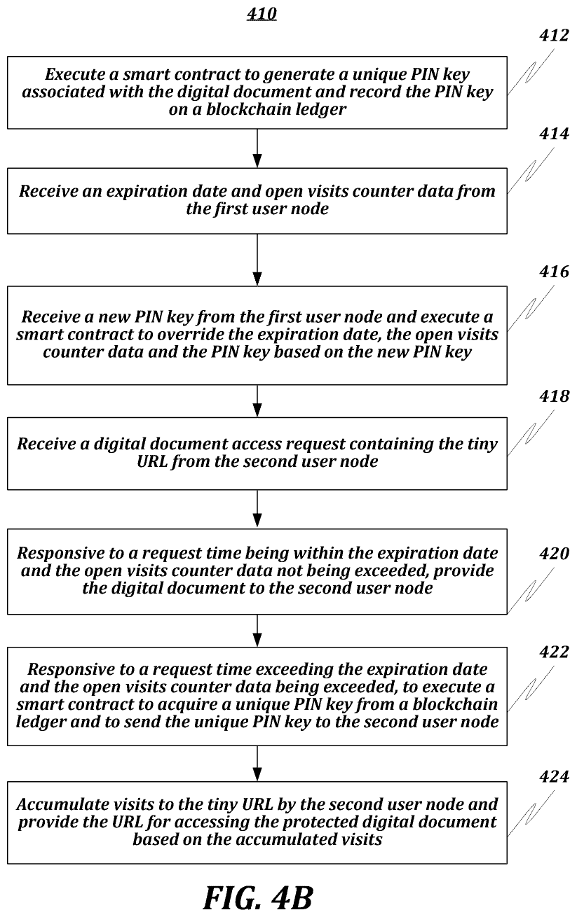

FIG. 4A illustrates a flow diagram 400 of an example method of QR code-based stamp generation, according to disclosed embodiments. Referring to FIG. 4A, the method 400 may include one or more of the steps described below.

FIG. 4A illustrates a flow chart of an example method executed by the stamp generation node 102 (see FIG. 1B). It should be understood that method 400 depicted in FIG. 4A may include additional operations and that some of the operations described therein may be removed and/or modified without departing from the scope of the method 400. The description of the method 400 is also made with reference to the features depicted in FIG. 1B for purposes of illustration. Particularly, the processor 104 of the stamp generation node 102 may execute some or all of the operations included in the method 400.

With reference to FIG. 4A, at block 402, the processor 104 may receive a digital document from the first user node designated to the second user node. At block 404, the processor 104 may execute a smart contract to generate a URL referencing a QR code and a unique tiny URL represented by the QR code. At block 406, the processor 104 may execute a smart contract to embed the QR code onto the document, wherein the document is accessible at the URL. At block 408, the processor 104 may execute a smart contract to provide the tiny URL to the second node.

FIG. 4B illustrates a further flow diagram 410 of an example method of QR code-based stamp generation, according to disclosed embodiments. Referring to FIG. 4B, the method 410 may include one or more of the steps described below.

FIG. 4B illustrates a flow chart of an example method executed by the QR code-based stamp generation 102 (see FIG. 1B). It should be understood that method 410 depicted in FIG. 4B may include additional operations and that some of the operations described therein may be removed and/or modified without departing from the scope of the method 410. The description of the method 410 is also made with reference to the features depicted in FIG. 1B for purposes of illustration. Particularly, the processor 104 of the QR code-based stamp generation node 102 may execute some or all of the operations included in the method 410.

With reference to FIG. 4B, at block 412, the processor 104 may execute a smart contract to generate a unique PIN key associated with the digital document and record the PIN key on a blockchain ledger. At block 414, the processor 104 may receive an expiration date and open visits counter data from the first user node. At block 416, the processor 104 may receive a new PIN key from the first user node and execute a smart contract to override the expiration date, the open visits counter data and the PIN key based on the new PIN key. At block 418, the processor 104 may receive a digital document access request containing the tiny URL from the second user node.

At block 420, the processor 104 may, responsive to a request time being within the expiration date and the open visits counter data not being exceeded, provide the digital document to the second user node. At block 422, the processor 104 may, responsive to a request time exceeding the expiration date and the open visits counter data being exceeded, to execute a smart contract to acquire a unique PIN key from a blockchain ledger and to send the unique PIN key to the second user node. At block 424, the processor 104 may, accumulate visits to the tiny URL by the second user node and provide the URL for accessing the protected digital document based on the accumulated visits.

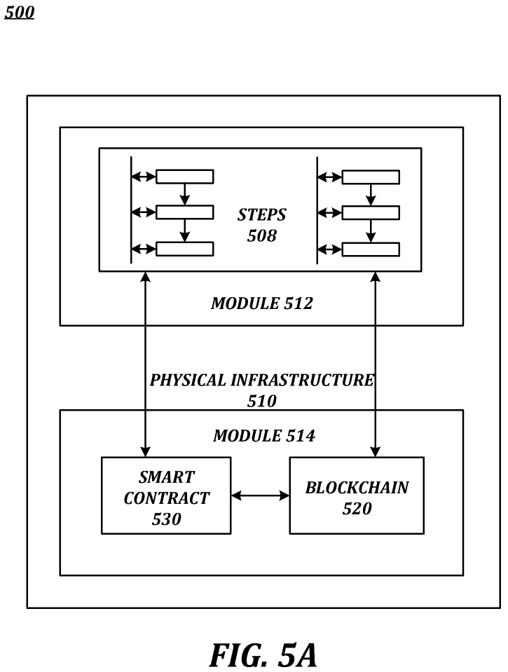

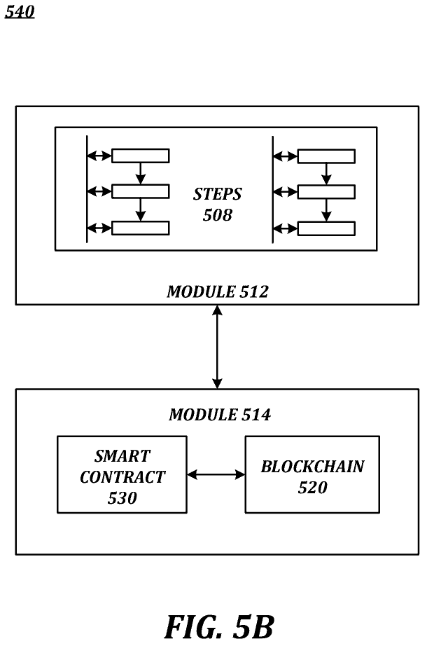

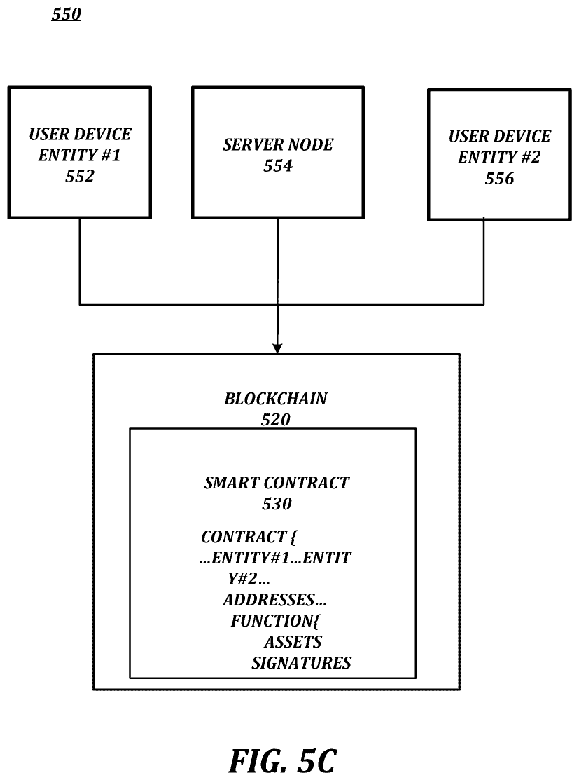

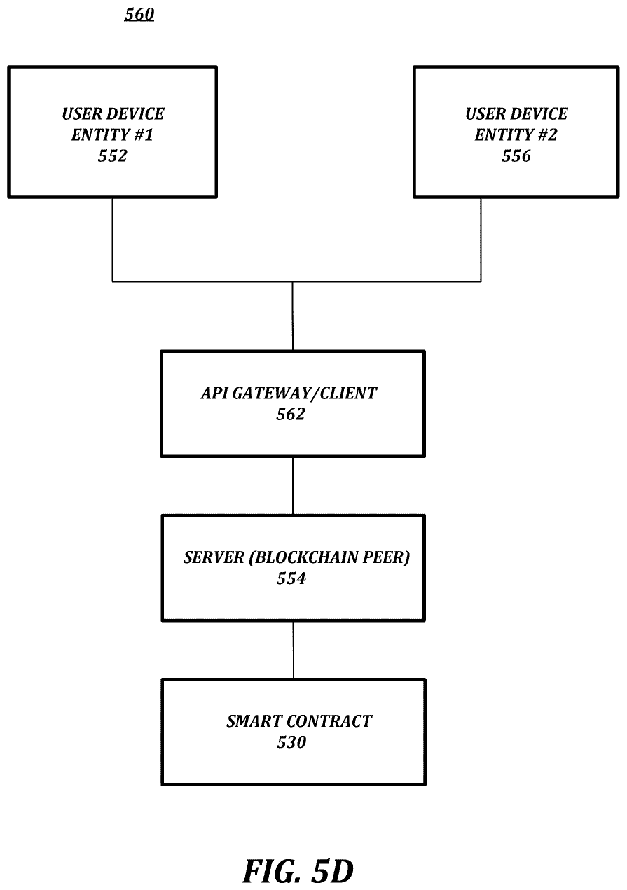

FIG. 5A illustrates an example system 500 that includes a physical infrastructure 510 configured to perform various operations according to example embodiments. Referring to FIG. 5A, the physical infrastructure 510 includes a module 512 and a module 514. The module 514 includes a blockchain 520 and a smart contract 530 (which may reside on the blockchain 520), that may execute any of the operational steps 508 (in module 512) included in any of the example embodiments. The steps/operations 508 may include one or more of the embodiments described or depicted and may represent output or written information that is written or read from one or more smart contracts 530 and/or blockchains 520. The physical infrastructure 510, the module 512, and the module 514 may include one or more computers, servers, processors, memories, and/or wireless communication devices. Further, the module 512 and the module 514 may be a same module.

FIG. 5B illustrates another example system 540 configured to perform various operations according to example embodiments. Referring to FIG. 5B, the system 540 includes a module 512 and a module 514. The module 514 includes a blockchain 520 and a smart contract 530 (which may reside on the blockchain 520), that may execute any of the operational steps 508 (in module 512) included in any of the example embodiments. The steps/operations 508 may include one or more of the embodiments described or depicted and may represent output or written information that is written or read from one or more smart contracts 530 and/or blockchains 520. The physical infrastructure 510, the module 512, and the module 514 may include one or more computers, servers, processors, memories, and/or wireless communication devices. Further, the module 512 and the module 514 may be a same module.

FIG. 5C illustrates an example system configured to utilize a smart contract configuration among contracting parties and a mediating server configured to enforce the smart contract terms on the blockchain according to example embodiments. Referring to FIG. 5C, the configuration 550 may represent a communication session, an asset (e.g., NFT) transfer session or a process or procedure that is driven by a smart contract 530 which explicitly identifies one or more user devices 552 and/or 556. The execution, operations and results of the smart contract execution may be managed by the NFT processing node (e.g., a server) 554. Content of the smart contract 530 may require digital signatures by one or more of the entities 552 and 556 which are parties to the smart contract transaction. The results of the smart contract execution may be written to a blockchain 520 as a blockchain transaction. The smart contract 530 resides on the blockchain 520 which may reside on one or more computers, servers, processors, memories, and/or wireless communication devices.

FIG. 5D illustrates a system 560 including a blockchain, according to example embodiments. Referring to the example of FIG. 5D, an application programming interface (API) gateway 562 provides a common interface for accessing blockchain logic (e.g., smart contract 530 or other chaincode) and data (e.g., distributed ledger, etc.). In this example, the API gateway 562 is a common interface for performing transactions (invoke, queries, etc.) on the blockchain by connecting one or more entities 552 and 556 to a blockchain peer (i.e., server 554). Here, the server 554 is a blockchain network peer component that holds a copy of the world state and a distributed ledger allowing clients 552 and 556 to query data on the world state as well as submit transactions into the blockchain network where, depending on the smart contract 530 and endorsement policy, endorsing peers will run the smart contracts 530.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

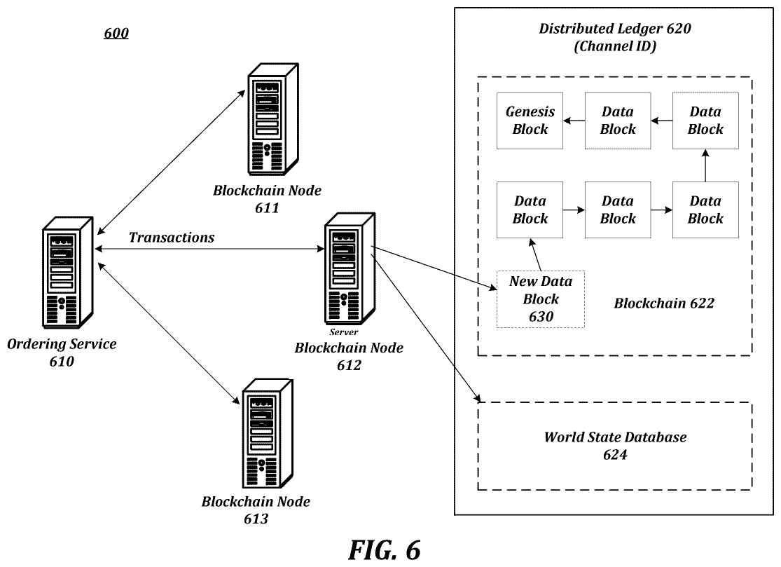

FIG. 6 illustrates a process 600 of a new block being added to a distributed ledger 620, according to example embodiments. Referring to FIG. 6, clients (not shown) may submit transactions to blockchain nodes 611, 612, and/or 613. Clients may use instructions received from any source to enact activity on the blockchain 620. As an example, the clients may be applications that act on behalf of a requester, such as a device, person or entity to propose transactions for the blockchain. The plurality of blockchain peers (e.g., blockchain nodes 611, 612, and 613) may maintain a state of the blockchain network and a copy of the distributed ledger 620. Different types of blockchain nodes/peers may be present in the blockchain network including endorsing peers which simulate and endorse transactions proposed by clients and committing peers which verify endorsements, validate transactions, and commit transactions to the distributed ledger 620. In this example, the blockchain nodes 611, 612, and 613 may perform the role of endorser node, committer node, or both.

The distributed ledger 620 includes a blockchain which stores immutable, sequenced records in blocks, and a state database 624 (current world state) maintaining a current state of the blockchain 622. One distributed ledger 620 may exist per channel and each peer maintains its own copy of the distributed ledger 620 for each channel of which they are a member. The blockchain 622 is a transaction log, structured as hash-linked blocks where each block contains a sequence of N transactions. The linking of the blocks (shown by arrows) may be generated by adding a hash of a prior block's header within a block header of a current block. In this way, all transactions on the blockchain 622 are sequenced and cryptographically linked together preventing tampering with blockchain data without breaking the hash links. Furthermore, because of the links, the latest block in the blockchain 622 represents every transaction that has come before it. The blockchain 622 may be stored on a peer file system (local or attached storage), which supports an append-only blockchain workload.

The current state of the blockchain 622 and the distributed ledger 620 may be stored in the state database 624. Here, the current state data represents the latest values for all keys ever included in the chain transaction log of the blockchain 622. Chaincode invocations execute transactions against the current state in the state database 624. To make these chaincode interactions extremely efficient, the latest values of all keys are stored in the state database 624. The state database 624 may include an indexed view into the transaction log of the blockchain 622, it can therefore be regenerated from the chain at any time. The state database 624 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction.” Different channels may have different endorsement policies. Endorsed transactions are forward by the client application to ordering service 610.

The ordering service 610 accepts endorsed transactions, orders them into a block, and delivers the blocks to the committing peers. For example, the ordering service 610 may initiate a new block when a threshold of transactions has been reached, a timer times out, or another condition. In the example depicted in FIG. 6, blockchain node 612 is a committing peer that has received a new data block 630 for storage on blockchain 620. The first block in the blockchain may be referred to as a genesis block which includes information about the blockchain, its members, the data stored therein, etc.

The ordering service 610 may be made up of a cluster of orderers. The ordering service 610 does not process transactions, smart contracts, or maintain the shared ledger. Rather, the ordering service 610 may accept the endorsed transactions and specifies the order in which those transactions are committed to the distributed ledger 620. The architecture of the blockchain network may be designed such that the specific implementation of ‘ordering’ (e.g., Solo, Kafka, BFT, etc.) becomes a pluggable component.

Transactions are written to the distributed ledger 620 in a consistent order. The order of transactions is established to ensure that the updates to the state database 624 are valid when they are committed to the network. Unlike a cryptocurrency blockchain system (e.g., Bitcoin, etc.) where ordering occurs through the solving of a cryptographic puzzle, or mining, in this example the parties of the distributed ledger 620 may choose the ordering mechanism that best suits that network.

When the ordering service 610 initializes a new data block 630, the new data block 630 may be broadcast to committing peers (e.g., blockchain nodes 611, 612, and 613). In response, each committing peer validates the transaction within the new data block 630 by checking to make sure that the read set and the write set still match the current world state in the state database 624. Specifically, the committing peer can determine whether the read data that existed when the endorsers simulated the transaction is identical to the current world state in the state database 624. When the committing peer validates the transaction, the transaction is written to the blockchain 622 on the distributed ledger 620, and the state database 624 is updated with the write data from the read-write set. If a transaction fails, that is, if the committing peer finds that the read-write set does not match the current world state in the state database 624, the transaction ordered into a block will still be included in that block, but it will be marked as invalid, and the state database 624 will not be updated.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

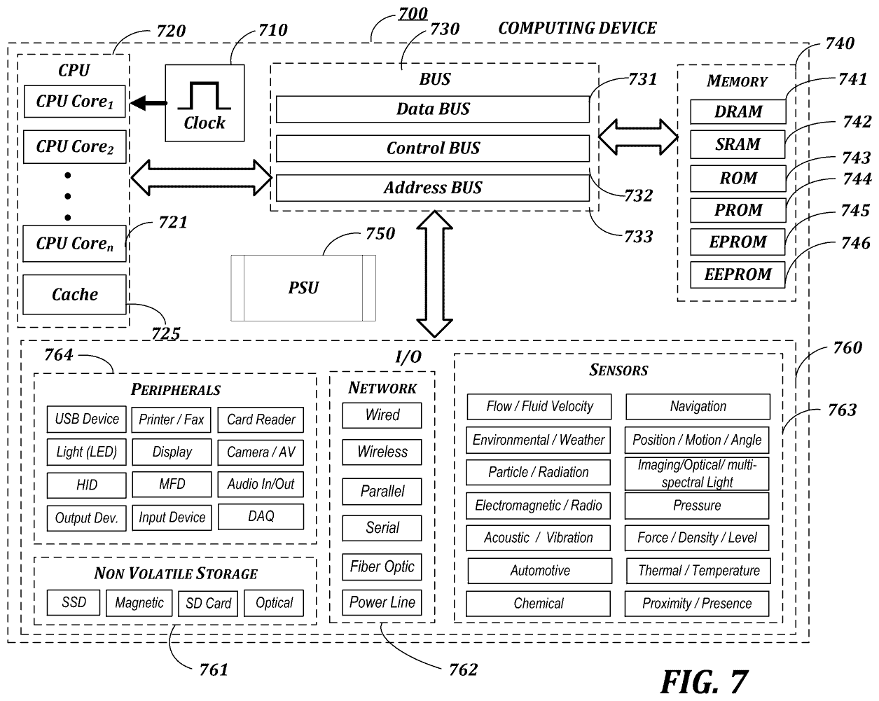

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 7 illustrates an example computing device (e.g., a server node) 700, which may represent or be integrated in any of the above-described components, etc.

FIG. 7 illustrates a block diagram of a system including computing device 700. The computing device 700 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS700/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The stamp generation node 102 (see FIG. 1A) may be hosted on a centralized server or on a cloud computing service. Although method 400 has been described to be performed by the stamp generation 102 implemented on a computing device 700, it should be understood that, in some embodiments, different operations may be performed by a plurality of the computing devices 700 in operative communication at least one network.

Embodiments of the present disclosure may comprise a computing device having a central processing unit (CPU) 720, a bus 730, a memory unit 770, a power supply unit (PSU) 750, and one or more Input/Output (I/O) units. The CPU 720 coupled to the memory unit 770 and the plurality of I/O units 760 via the bus 730, all of which are powered by the PSU 750. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 720, the bus 730, the memory unit 770, a PSU 750, and the plurality of I/O units 760 may be implemented in a computing device, such as computing device 700. Any suitable combination of hardware, software, or firmware may be used to implement the aforementioned units. For example, the CPU 720, the bus 730, and the memory unit 770 may be implemented with computing device 700 or any of other computing devices 700, in combination with computing device 700. The aforementioned system, device, and components are examples and other systems, devices, and components may comprise the aforementioned CPU 720, the bus 730, the memory unit 770, consistent with embodiments of the disclosure.

At least one computing device 700 may be embodied as any of the computing elements illustrated in all of the attached figures, including the stamp generation 102 (FIG. 1B). A computing device 700 does not need to be electronic, nor even have a CPU 720, nor bus 730, nor memory unit 770. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In a basic configuration, computing device 700 may include at least one clock module 710, at least one CPU 720, at least one bus 730, and at least one memory unit 770, at least one PSU 750, and at least one I/O 760 module, wherein I/O module may be comprised of, but not limited to a non-volatile storage sub-module 761, a communication sub-module 762, a sensors sub-module 763, and a peripherals sub-module 767.

A system consistent with an embodiment of the disclosure the computing device 700 may include the clock module 710 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 720, the central component of modern computers, which relies on a clock. The only exceptions are asynchronous circuits such as asynchronous CPUs. The clock 710 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 7 wires.

Many computing devices 700 use a “clock multiplier” which multiplies a lower frequency external clock to the appropriate clock rate of the CPU 720. This allows the CPU 720 to operate at a much higher frequency than the rest of the computer, which affords performance gains in situations where the CPU 720 does not need to wait on an external factor (like memory 770 or input/output 760). Some embodiments of the clock 710 may include dynamic frequency change, where, the time between clock edges can vary widely from one edge to the next and back again.

A system consistent with an embodiment of the disclosure the computing device 700 may include the CPU unit 720 comprising at least one CPU Core 721. A plurality of CPU cores 721 may comprise identical CPU cores 721, such as, but not limited to, homogeneous multi-core systems. It is also possible for the plurality of CPU cores 721 to comprise different CPU cores 721, such as, but not limited to, heterogeneous multi-core systems, big.LITTLE systems and some AMD accelerated processing units (APU). The CPU unit 720 reads and executes program instructions which may be used across many application domains, for example, but not limited to, general purpose computing, embedded computing, network computing, digital signal processing (DSP), and graphics processing (GPU). The CPU unit 720 may run multiple instructions on separate CPU cores 721 at the same time. The CPU unit 720 may be integrated into at least one of a single integrated circuit die and multiple dies in a single chip package. The single integrated circuit die and multiple dies in a single chip package may contain a plurality of other aspects of the computing device 700, for example, but not limited to, the clock 710, the CPU 720, the bus 730, the memory 770, and I/O 760.

The CPU unit 720 may contain cache 722 such as, but not limited to, a level 1 cache, level 2 cache, level 3 cache or combination thereof. The aforementioned cache 722 may or may not be shared amongst a plurality of CPU cores 721. The cache 722 sharing comprises at least one of message passing and inter-core communication methods may be used for the at least one CPU Core 721 to communicate with the cache 722. The inter-core communication methods may comprise, but not limited to, bus, ring, two-dimensional mesh, and crossbar. The aforementioned CPU unit 720 may employ symmetric multiprocessing (SMP) design.

The plurality of the aforementioned CPU cores 721 may comprise soft microprocessor cores on a single field programmable gate array (FPGA), such as semiconductor intellectual property cores (IP Core). The plurality of CPU cores 721 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the aforementioned computing device 700, and/or the plurality of computing devices 700. The aforementioned communication system will be known to a person having ordinary skill in the art as a bus 730. The bus 730 may embody internal and/or external plurality of hardware and software components, for example, but not limited to a wire, optical fiber, communication protocols, and any physical arrangement that provides the same logical function as a parallel electrical bus. The bus 730 may comprise at least one of, but not limited to a parallel bus, wherein the parallel bus carry data words in parallel on multiple wires, and a serial bus, wherein the serial bus carry data in bit-serial form. The bus 730 may embody a plurality of topologies, for example, but not limited to, a multidrop/electrical parallel topology, a daisy chain topology, and a connected by switched hubs, such as USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/107 bus (e.g., PC/107-Plus, PCI/107-Express, PCI/107, and PCI-107), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1397 Interface/Firewire, Thunderbolt, and extensible Host Controller Interface (xHCI).

Consistent with the embodiments of the present disclosure, the aforementioned computing device 700 may employ hardware integrated circuits that store information for immediate use in the computing device 700, know to the person having ordinary skill in the art as primary storage or memory 770. The memory 770 operates at high speed, distinguishing it from the non-volatile storage sub-module 761, which may be referred to as secondary or tertiary storage, which provides slow-to-access information but offers higher capacities at lower cost. The contents contained in memory 770, may be transferred to secondary storage via techniques such as, but not limited to, virtual memory and swap. The memory 770 may be associated with addressable semiconductor memory, such as integrated circuits consisting of silicon-based transistors, used for example as primary storage but also other purposes in the computing device 700. The memory 770 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 771, Static Random-Access Memory (SRAM) 772, CPU Cache memory 725, Advanced Random-Access Memory (A-RAM), and other types of primary storage such as Random-Access Memory (RAM).
Non-volatile memory which can retain stored information even after power is removed, for example, but not limited to, Read-Only Memory (ROM) 773, Programmable ROM (PROM) 777, Erasable PROM (EPROM) 775, Electrically Erasable PROM (EEPROM) 776 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 700 may employ the communication system between an information processing system, such as the computing device 700, and the outside world, for example, but not limited to, human, environment, and another computing device 700. The aforementioned communication system will be known to a person having ordinary skill in the art as I/O 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces a plurality of hardware, such as, but not limited to, non-volatile storage 761, communication devices 762, sensors 763, and peripherals 767. The plurality of hardware is used by the at least one of, but not limited to, human, environment, and another computing device 700 to communicate with the present computing device 700. The I/O module 760 may comprise a plurality of forms, for example, but not limited to channel I/O, port mapped I/O, asynchronous I/O, and Direct Memory Access (DMA).
Consistent with the embodiments of the present disclosure, the aforementioned computing device 700 may employ the non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using intermediate area in the memory 770. The non-volatile storage sub-module 761 does not lose data when power is removed and may be two orders of magnitude less costly than storage used in memory module, at the expense of speed and latency. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 700 may employ the communication sub-module 762 as a subset of the I/O 760, which may be referred to by a person having ordinary skill in the art as at least one of, but not limited to, computer network, data network, and network. The network allows computing devices 700 to exchange data using connections, which may be known to a person having ordinary skill in the art as data links, between network nodes. The nodes comprise network computer devices 700 that originate, route, and terminate data. The nodes are identified by network addresses and can include a plurality of hosts consistent with the embodiments of a computing device 700. The aforementioned embodiments include, but not limited to personal computers, phones, servers, drones, and networking devices such as, but not limited to, hubs, switches, routers, modems, and firewalls.

Two nodes can be said are networked together, when one computing device 700 is able to exchange information with the other computing device 700, whether or not they have a direct connection with each other. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 7 [IPv7], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 762 may comprise a plurality of size, topology, traffic control mechanism and organizational intent. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,7G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 700 may employ the sensors sub-module 763 as a subset of the I/O 760. The sensors sub-module 763 comprises at least one of the devices, modules, and subsystems whose purpose is to detect events or changes in its environment and send the information to the computing device 700. Sensors are sensitive to the measured property, are not sensitive to any property not measured, but may be encountered in its application, and do not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical s sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (O2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermo-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LIDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo-capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ the peripherals sub-module 762 as a subset of the I/O 760. The peripheral sub-module 767 comprises ancillary devices uses to put information into and get information out of the computing device 700. There are 3 categories of devices comprising the peripheral sub-module 767, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 700. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 767:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 700. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 700 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 762 sub-module), data storage device (non-volatile storage 761), facsimile (FAX), and graphics/sound cards.

### Aspects

The following discloses various Aspects of the present disclosure. The various Aspects are not to be construed as patent claims unless the language of the Aspect appears as a patent claim. The Aspects describe various non-limiting embodiments of the present disclosure.

Aspect 1. A system, comprising:
a processor of a stamp generation node connected to at least first user node and to a second user node over a blockchain network;
a memory on which are stored machine-readable instructions that when executed by the processor, cause the processor to:
receive a digital document from the first user node designated to the second user node; and
execute a smart contract to:
generate a Uniform Resource Locator (URL) referencing a Quick-Response (QR) code and a unique tiny URL represented by the QR code,
embed the QR code onto the document, wherein the document is accessible at the URL,
accumulate visits to the tiny URL by the second user node, and
provide the tiny URL to the second user node for accessing the protected digital document based on the accumulated visits.

Aspect 2. The system of Aspect 1, wherein the instructions further cause the processor to execute a smart contract to generate a unique Personal Identification Number (PIN) key associated with the digital document and record the PIN key on a blockchain ledger.

Aspect 3. The system of Aspect 2, wherein the instructions further cause the processor to receive an expiration date and open visits counter data from the first user node.

Aspect 4. The system of Aspect 3, wherein the instructions further cause the processor to receive a new PIN key from the first user node and execute a smart contract to override the expiration date, the open visits counter data and the PIN key based on the new PIN key.

Aspect 5. The system of Aspect 1, wherein the instructions further cause the processor to receive a digital document access request containing the tiny URL from the second user node.

Aspect 6. The system of Aspect 4, wherein the instructions further cause the processor to, responsive to a request time being within the expiration date and the open visits counter data not being exceeded, provide the digital document to the second user node.

Aspect 7. The system of Aspect 4, wherein the instructions further cause the processor to, responsive to a request time exceeding the expiration date and the open visits counter data being exceeded, to execute a smart contract to acquire a unique PIN key from a blockchain ledger and to send the unique PIN key to the second user node.

Aspect 8. A method, comprising:
receiving, by a stamp generation node, a digital document from a first user node designated to a second user node; and
executing, by the stamp generation node, a smart contract to:
generate a Uniform Resource Locator (URL) referencing a Quick-Response (QR) code and a unique tiny URL represented by the QR code,
embed the QR code onto the document, wherein the document is accessible at the URL,
accumulate visits to the tiny URL by the second user node, and
provide the tiny URL to the second user node for accessing the protected digital document based on the accumulated visits.

Aspect 9. The method of Aspect 8, further comprising executing a smart contract to generate a unique Personal Identification Number (PIN) key associated with the digital document and record the PIN key on a blockchain ledger.

Aspect 10. The method of Aspect 8, further comprising receiving an expiration date and open visits counter data from the first user node.

Aspect 11. The method of Aspect 10, further comprising receiving a new PIN key from the first user node and executing a smart contract to override the expiration date, the open visits counter data and the PIN key based on the new PIN key.

Aspect 12. The method of Aspect 8, further comprising receiving a digital document access request containing the tiny URL from the second user node.

Aspect 13. The method of Aspect 11, further comprising, responsive to a request time being within the expiration date and the open visits counter data not being exceeded, providing the digital document to the second user node.

Aspect 14. The method of Aspect 11, further comprising, responsive to a request time exceeding the expiration date and the open visits counter data being exceeded, executing a smart contract to acquire a unique PIN key from a blockchain ledger and to send the unique PIN key to the second user node.

Aspect 15. A non-transitory computer readable medium comprising instructions, that when read by a processor, cause the processor to perform:
receiving a digital document from a first user node designated to a second user node; and
executing a smart contract to:
generate a Uniform Resource Locator (URL) referencing a Quick-Response (QR) code and a unique tiny URL represented by the QR code,
embed the QR code onto the document, wherein the document is accessible at the URL,
accumulate visits to the tiny URL by the second user node, and
provide the tiny URL to the second user node for accessing the protected digital document based on the accumulated visits.

Aspect 16. The non-transitory computer readable medium of Aspect 15, further comprising instructions, that when read by the processor, cause the processor to execute a smart contract to generate a unique Personal Identification Number (PIN) key associated with the digital document and record the PIN key on a blockchain ledger.

Aspect 17. The non-transitory computer readable medium of Aspect 15, further comprising instructions, that when read by the processor, cause the processor to, responsive to a request time being within an expiration date and open visits counter data not being exceeded, provide the digital document to the second user node.

Aspect 18. The non-transitory computer readable medium of Aspect 15, further comprising instructions, that when read by the processor, cause the processor to, responsive to a request time exceeding an expiration date and open visits counter data being exceeded, execute a smart contract to acquire a unique PIN key from a blockchain ledger and to send the unique PIN key to the second user node.

Aspect 19. A system, comprising:
a processor of a stamp generation node connected to at least first user node and to a second user node over a blockchain network;
a memory on which are stored machine-readable instructions that when executed by the processor, cause the processor to:
receive a digital document from the first user node designated to the second user node; and
execute a smart contract to:
generate a Uniform Resource Locator (URL) referencing a Quick-Response (QR) code and a unique tiny URL represented by the QR code,
embed the QR code onto the document, wherein the document is accessible at the URL,
generate a unique Personal Identification Number (PIN) key associated with the digital document and record the PIN key on a blockchain ledger,
receive an expiration date and open visits counter data from the first user node,
provide the tiny URL to the second user node; and
responsive to a request time from the second user node exceeding the expiration date and the open visits counter data being exceeded, acquire a unique PIN key from a blockchain ledger and send the unique PIN key to the second user node.

Aspect 20. A method, comprising:
receiving, by a stamp generation node, a digital document from a first user node designated to a second user node; and
executing, by the stamp generation node, a smart contract to:
generate a Uniform Resource Locator (URL) referencing a Quick-Response (QR) code and a unique tiny URL represented by the QR code,
embed the QR code onto the document, wherein the document is accessible at the URL,
generate a unique Personal Identification Number (PIN) key associated with the digital document and record the PIN key on a blockchain ledger,
receive an expiration date and open visits counter data from the first user node,
provide the tiny URL to the second user node; and
responsive to a request time from the second user node exceeding the expiration date and the open visits counter data being exceeded, acquire a unique PIN key from a blockchain ledger and send the unique PIN key to the second user node.

Aspect 21. A non-transitory computer readable medium comprising instructions, that when read by a processor, cause the processor to perform:
receiving a digital document from a first user node designated to a second user node; and
executing a smart contract to:
generate a Uniform Resource Locator (URL) referencing a Quick-Response (QR) code and a unique tiny URL represented by the QR code,
embed the QR code onto the document, wherein the document is accessible at the URL,
generate a unique Personal Identification Number (PIN) key associated with the digital document and record the PIN key on a blockchain ledger,
receive an expiration date and open visits counter data from the first user node,
provide the tiny URL to the second user node; and
responsive to a request time from the second user node exceeding the expiration date and the open visits counter data being exceeded, acquire a unique PIN key from a blockchain ledger and send the unique PIN key to the second user node.

The following is claimed:

1. A system for protecting access to digital documents, comprising:
a blockchain network;
a stamp generation node connected to the blockchain network, the stamp generation node comprising:
a processor; and
a memory storing instructions that, when executed by the processor, cause the processor to:
receive, from a first user node, a digital document and access parameters for the digital document;
generate a unique identifier for the digital document;
record the unique identifier and access parameters on the blockchain network;
generate a QR code encoding a URL for accessing the digital document;
embed the QR code in the digital document;
generate a shortened URL corresponding to the URL encoded in the QR code; and
transmit the shortened URL to a second user node;
wherein the shortened URL, when accessed by the second user node, causes the stamp generation node to:
verify the access parameters recorded on the blockchain network; and
grant or deny access to the digital document based on the verification.

2. The system of claim 1, wherein the access parameters comprise at least one of:
an expiration date for accessing the digital document;
a maximum number of times the digital document can be accessed; and
a list of authorized users who can access the digital document.

3. The system of claim 1, wherein the instructions further cause the processor to:
generate a unique PIN associated with the digital document; and
record the unique PIN on the blockchain network.

4. The system of claim 3, wherein granting access to the digital document comprises:
prompting the second user node to enter the unique PIN; and
verifying the entered PIN matches the PIN recorded on the blockchain network.

5. The system of claim 1, wherein the instructions further cause the processor to:
track a number of times the shortened URL is accessed; and
record the number of times accessed on the blockchain network.

6. The system of claim 1, wherein verifying the access parameters comprises:
retrieving the access parameters and unique identifier from the blockchain network using the URL encoded in the QR code; and
comparing a current date and time to the access parameters to determine if access is permitted.

7. The system of claim 1, wherein the instructions further cause the processor to:
receive an updated set of access parameters from the first user node; and
execute a smart contract to update the access parameters recorded on the blockchain network.

8. A method for securely sharing digital documents, comprising:
receiving, by a stamp generation node on a blockchain network, a digital document from a first user node;
generating, by the stamp generation node, a unique identifier for the digital document;
recording, by the stamp generation node, the unique identifier on a blockchain ledger of the blockchain network;
generating, by the stamp generation node, a URL for accessing the digital document;
creating, by the stamp generation node, a QR code that encodes the URL;
embedding, by the stamp generation node, the QR code into the digital document;
generating, by the stamp generation node, a shortened URL that corresponds to the URL encoded in the QR code;
transmitting, by the stamp generation node, the shortened URL to a second user node;
receiving, by the stamp generation node, an access request from the second user node containing the shortened URL;
verifying, by the stamp generation node, access permissions for the second user node by querying the blockchain ledger; and
providing, by the stamp generation node, access to the digital document to the second user node in response to a determination that the access permissions are valid.

9. The method of claim 8, further comprising:
receiving, by the stamp generation node, access parameters for the digital document from the first user node; and
recording, by the stamp generation node, the access parameters on the blockchain ledger in association with the unique identifier.

10. The method of claim 9, wherein the access parameters comprise at least one of:
an expiration date for accessing the digital document;
a maximum number of times the digital document can be accessed; and
a list of authorized users who can access the digital document.

11. The method of claim 8, further comprising:
generating, by the stamp generation node, a unique PIN associated with the digital document; and
recording, by the stamp generation node, the unique PIN on the blockchain ledger.

12. The method of claim 11, wherein providing access to the digital document comprises:
prompting, by the stamp generation node, the second user node to enter the unique PIN; and
verifying, by the stamp generation node, that the entered PIN matches the PIN recorded on the blockchain ledger.

13. The method of claim 8, further comprising:
tracking, by the stamp generation node, a number of times the shortened URL is accessed; and
recording, by the stamp generation node, the number of times accessed on the blockchain ledger.

14. The method of claim 8, further comprising:
receiving, by the stamp generation node, an updated set of access parameters from the first user node; and
executing, by the stamp generation node, a smart contract to update the access parameters recorded on the blockchain ledger.

15. A blockchain-based system for controlling access to digital documents, comprising:
a plurality of nodes on a blockchain network, including:
a first user node configured to submit a digital document for protected sharing;
a second user node configured to request access to the digital document; and
a stamp generation node configured to:
receive the digital document from the first user node;
generate a unique identifier for the digital document;
record the unique identifier on a blockchain ledger;
generate a URL for accessing the digital document;
create a QR code encoding the URL;
embed the QR code in the digital document;
generate a shortened URL corresponding to the URL;
transmit the shortened URL to the second user node;
receive an access request from the second user node containing the shortened URL;
retrieve one or more access parameters associated with the unique identifier from the blockchain ledger;
verify the access request against the access parameters; and
grant access to the digital document based on the verification that the access request meets the retrieved access parameters.

16. The system of claim 15, wherein the stamp generation node is further configured to:
generate a unique PIN associated with the digital document;
record the unique PIN on the blockchain ledger; and
require entry of the unique PIN by the second user node before granting access to the digital document.

17. The system of claim 15, wherein the access parameters include at least one of:
an expiration date for accessing the digital document;
a maximum number of times the digital document can be accessed; and
a list of authorized users who can access the digital document.

18. The system of claim 15, wherein the stamp generation node is further configured to:
track a number of times the shortened URL is accessed; and
record the number of times accessed on the blockchain ledger.

19. The system of claim 15, wherein the stamp generation node is further configured to:
receive updated access parameters from the first user node; and
execute a smart contract to update the access parameters recorded on the blockchain ledger.

20. The system of claim 15, wherein verifying the access request comprises:
retrieving the access parameters from the blockchain ledger using the URL encoded in the QR code; and
comparing a current date and time to the access parameters to determine if access is permitted.
